(19) United States
(12) Patent Application Publication
(10) Pub. No.: US 2025/0182948 A1
(43) Pub. Date: Jun. 5, 2025

(54) LEADLESS TRANSFORMER PACKAGES

(71) Applicant: Allegro MicroSystems, LLC, Manchester, NH (US)

(72) Inventors: Harry Chandra, Phoenix, AZ (US); Natasha Healey, Manchester, NH (US)

(73) Assignee: Allegro MicroSystems, LLC, Manchester, NH (US)

(21) Appl. No.: 18/524,130

(22) Filed: Nov. 30, 2023

(51) Int. Cl. H01F 27/02; H01F 27/24; H01F 27/28; H01F 41/02; H01F 41/04

(52) U.S. Cl. CPC H01F 27/022; H01F 27/24; H01F 27/28; H01F 41/0206; H01F 41/04

(57) ABSTRACT

Systems, structures, packages, circuits, and methods provide leadless transformer packages for galvanic isolation. An example leadless transformer includes a substrate including opposed first and second surfaces and a plurality of conductive traces. The plurality of conductive traces includes a first group and a second group that are galvanically separate. The first group includes a plurality of exposed portions that are exposed at a first area of the substrate and the second group includes a plurality of exposed portions that are exposed at a second area of the substrate. A magnetic core is disposed on the substrate. First and second coils are each disposed about the magnetic core and configured for connection to the first and second groups of conductive traces, respectively. The package includes a dam disposed on the substrate and configured to surround the magnetic core, and an encapsulant is within the dam, encapsulating the magnetic core.

### BACKGROUND

Solid state switches typically include a transistor structure. The controlling electrode of the switch, usually referred to as its gate (or base), is typically controlled (driven) by a switch drive circuit, sometimes also referred to as gate drive circuit. Such solid state switches are typically voltage-controlled, turning on when the gate voltage exceeds a manufacturer-specific threshold voltage by a margin, and turning off when the gate voltage remains below the threshold voltage by a margin.

Switch drive circuits typically receive their control instructions from a controller such as a pulse-width-modulated (PWM) controller via one or more switch driver inputs. Switch drive circuits deliver their drive signals directly (or indirectly via networks of active and passive components) to the respective terminals of the switch (gate and source).

Some electronic systems, including ones with solid state switches, have employed galvanic isolation to prevent undesirable DC currents flowing from one side of an isolation barrier to the other. Such galvanic isolation can be used to separate circuits in order to protect users from coming into direct contact with hazardous voltages.

Various transmission techniques are available for signals to be sent across galvanic isolation barriers including optical, capacitive, and magnetic coupling techniques. Magnetic coupling typically relies on use of a transformer to magnetically couple circuits on the different sides of the transformer, typically referred to as the primary and secondary sides, while also providing galvanic separation of the circuits.

Transformers used for magnetic-coupling isolation barriers typically utilize a magnetic core to provide a magnetic path to channel flux created by the currents flowing in the primary and secondary sides of the transformer. Magnetic-coupling isolation barriers have been shown to have various drawbacks, including manufacturing problems, for integrated circuit (IC) packages due to the included magnetic core.

### SUMMARY

Aspects of the present disclosure are directed to leadless transformer packages. Embodiments can include or utilize laminated substrate structures.

One general aspect of the present disclosure includes a leadless transformer package that includes: a substrate including opposed first and second surfaces and a plurality of conductive traces, where the plurality of conductive traces includes a first group and a second group that are galvanically separate, and where the first group includes a plurality of exposed portions that are exposed at a first area of the substrate, and the second group includes a plurality of exposed portions that are exposed at a second area of the substrate; a magnetic core disposed on the substrate, where the magnetic core may include a soft magnetic material; first and second coils each disposed about the magnetic core and configured for connection to the first and second groups of conductive traces, respectively; a dam disposed on the substrate and configured to surround the magnetic core; and an encapsulant disposed within the dam and encapsulating the magnetic core.

Implementations may include one or more of the following features. The dam of the transformer package may include a plurality of walls disposed on the first surface of the substrate. The dam may include a cover connecting the plurality of walls. The substrate may include a laminated structure. The substrate may include a printed circuit board (PCB). The PCB may include FR4, FR5, and/or another substrate material. The substrate may include one or more layers of low-temperature cofired ceramic (LTCC) or high-temperature cofired ceramic (HTCC). The substrate may include an alumina substrate. The substrate may include a glass substrate, which may include one or more layers of metal and insulation. The first coil and/or second coil may include insulated wire. The first coil and/or second coil may include uninsulated wire. The first coil and/or second coil may include insulated ribbon cables. The first coil and/or second coil may include flexible ribbon cables. The first and second coils can be configured as primary and secondary coils in a step-up configuration. The magnetic core may include ferrite. The magnetic core may include a nickel alloy. The magnetic core may include a ferrosilicon. The magnetic core may include iron particles. The encapsulant may include silicone.

One general aspect of the present disclosure includes a method of making a leadless transformer package. The method includes: providing a substrate including opposed first and second surfaces and a plurality of conductive traces, where the plurality of conductive traces includes a first group and a second group that are galvanically separate, and where the first group includes a plurality of exposed portions that are exposed at a first area of the substrate, and the second group includes a plurality of exposed portions that are exposed at a second area of the substrate; providing a magnetic core disposed on the substrate, where the magnetic core may include a soft magnetic material; providing first and second coils each disposed about the magnetic core and configured for connection to the first and second groups of conductive traces, respectively; providing a dam disposed on the substrate and configured to surround the magnetic core; and providing an encapsulant disposed within the dam and encapsulating the magnetic core.

Implementations may include one or more of the following features. The dam may include a plurality of walls (e.g., four) disposed on the first surface of the substrate. The walls may (completely or partially) surround the magnetic core and coils in some embodiments. The dam may include a cover connecting the plurality of walls. The substrate may include a laminated structure. The substrate may include a printed circuit board (PCB). The substrate may include one or more layers of low-temperature cofired ceramic (LTCC) or high-temperature cofired ceramic (HTCC). The substrate may include an alumina substrate. The substrate may include a glass substrate, which may include one or more layers of metal and insulation. The first coil and/or second coil may include insulated wire. The first coil and/or second coil may include uninsulated wire. The first and/or second coil may include insulated ribbon cables. The first coil and/or second coil may include flexible ribbon cables. The first and second coils are configured as primary and secondary coils in a step-up configuration. The magnetic core may include ferrite. The magnetic core may include a nickel alloy. The magnetic core may include ferrosilicon. The magnetic core may include iron particles. The encapsulant may include silicone.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed embodiments may be appreciated by reference to the figures of the accompanying drawings. In the figures like reference characters refer to like components, parts, elements, or steps/actions; however, similar components, parts, elements, and steps/actions may be referenced by different reference characters in different figures. It should be appreciated that the components and structures illustrated in the figures are not necessarily to scale, emphasis instead being placed upon illustrating the principals of the concepts described herein. Furthermore, embodiments are illustrated by way of example and not limitation in the figures, in which:

FIG. 1 is a perspective view of an example leadless transformer package, in accordance with the present disclosure;

FIG. 2 includes views (A)-(B) showing further examples of leadless transformer packages with different coil configurations, in accordance with the present disclosure;

FIG. 3 includes views (A)-(D) showing a further example of a leadless transformer package at different stages of fabrication, in accordance with the present disclosure; and

FIG. 4 shows a box diagram of an example method of fabricating a leadless transformer package, in accordance with the present disclosure.

### DETAILED DESCRIPTION

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

Aspects of the present disclosure are directed to and include systems, structures, circuits, and methods providing leadless transformer structures and packages that can be used for galvanic isolation (a.k.a., voltage isolation). In some embodiments, a leadless transformer package may have, e.g., a step up, a step down, or a power transformer configuration.

In some embodiments, e.g., transformer packages with step up configurations, a transformer of a transformer package may be used to provide voltage isolation for one or more IC die (e.g., first and second semiconductor die) having one or more integrated circuits (a.k.a., “IC die”). Such integrated circuits (packaged in die packages or modules or unpackaged) can include, e.g., but are not limited to, high-voltage circuits such as gate drivers configured to drive an external gate on a solid-state switch, e.g., a field effect transistor (FET), a metal oxide semiconductor FET (MOSFET), a metal semiconductor FET (MESFET), a gallium nitride FET (GaN FET), a high electron mobility transistor (HEMT), a silicon carbide FET (SiC FET), an insulated gate bipolar transistor (IGBT), or another load.

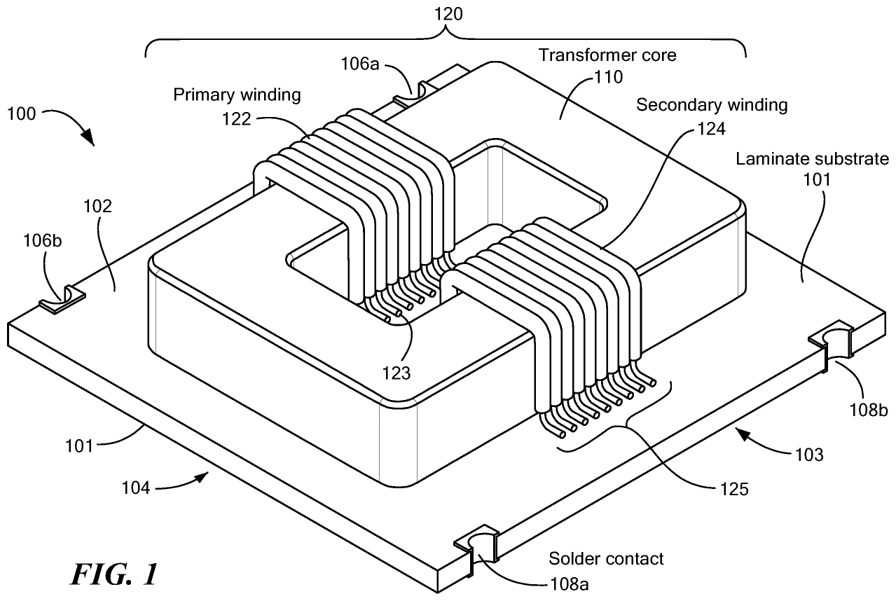

FIG. 1 is a perspective view of an example leadless transformer package 100, in accordance with the present disclosure. Package 100 includes a substrate 101 with opposed first and second surfaces (sides) 102, 103. Substrate 101 can include a laminated structure in some embodiments. In some embodiments, substrate 101 can include a printed circuit board (PCB), e.g., a PCB including FR4, FR5, or other PCB material(s). In some embodiments, substrate 101 can include one or more layers of low-temperature cofired ceramic (LTCC) or high-temperature cofired ceramic (HTCC). In some embodiments, substrate 101 can include an alumina substrate or a glass substrate comprising one or more layers of metal and insulation. Substrate 101 can include a plurality of conductive structures or traces 104, which may be on a surface of substrate 101 and/or included in the interior of substrate 101. The plurality of conductive traces 104, which can be made of any suitable conductive material(s), can include a first group and a second group that are galvanically separate from one another. The first group can include a plurality of exposed portions that are exposed at a first area (or areas) of the substrate 101 and the second group can include a plurality of exposed portions that are exposed at a second area (or areas) of the substrate 101, e.g., as indicated by solder contacts (pads) 106a-b and 108a-b, respectively. The exposed portions can be used, e.g., for input/output (I/O) purposes or functionality.

Package 100 also includes transformer 120 with primary coil 122 and secondary coil 124 configured about transformer core 110 and galvanically separated. Transformer core 110 can include one or more soft (referring to magnetic property) ferromagnetic materials. In some embodiments, core 110 can include ferrite, iron particles, ferrosilicon, nickel, nickel alloys (e.g., iron nickel), and/or the like. In some embodiments, core 110 can include a sintered soft ferromagnetic material. Primary coil 122 and secondary coil 124 can each have a desired number of windings, which may differ from coil to coil. Portions of primary and secondary coils 122 and 124 are shown configured (wound) about core 110 as insulated wire, with ends 123 and 125 connected to conductive structures 104 (not shown) on surface 102 and/or in substrate 101; other portions (not shown) of primary and secondary coils 122 and 124 are included (e.g., as conductive structures 104) within or on substrate 101 (e.g., as buried conductive traces), completing the windings of each coil 122, 124 about core 110. Insulating material (not shown) may be disposed between core 110 and substrate 101. Coils 122 and 124 can be connected to respective sets of connection structures, e.g., solder contacts 106a-b and 108a-b, respectively.

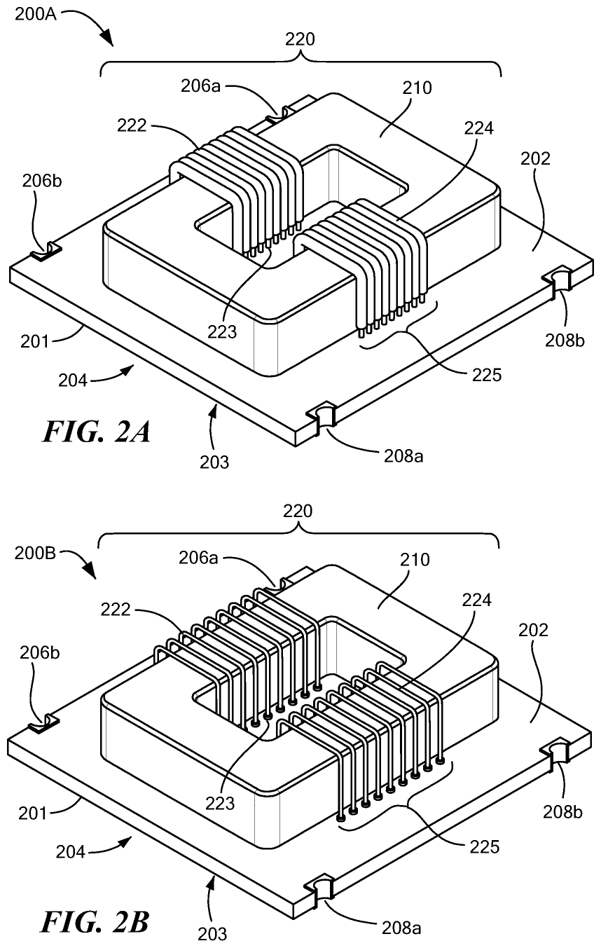

FIG. 2 includes views (A)-(B) showing further examples of leadless transformer packages 200A-200B with different coil configurations, in accordance with the present disclosure. Each of packages 200A and 200B includes a substrate 201 with opposed first and second surfaces (sides) 202, 203. In some embodiments, substrate 201 can include a printed circuit board (PCB). Substrate 201 can include a plurality of conductive structures 204, which may be on a surface of substrate 201 and/or included in the interior of substrate 201. Multiple structures for connection to other components can be included, e.g., as indicated by solder contacts 206a-b and 208a-b. Packages 200A and 200B also include transformer 220 with primary coil 222 and secondary coil 224, which are configured about transformer core 210 and galvanically separated. Transformer core 210 can include one or more soft (referring to magnetic property) ferromagnetic materials. Primary coil 222 and secondary coil 224 can each have a desired number of windings, which may differ from coil to coil. Portions of primary and secondary coils 222 and 224 are shown configured (wound) about core 210 as wire, with respective ends 223 and 225 connected to conductive structures on surface 202 or in substrate 201; other portions (not shown) of primary and secondary coils 222 and 224 are included within or on substrate 201 (e.g., as buried conductive traces), completing the windings about core 210. Coils 222 and 224 can be connected to respective sets of connection structures, e.g., solder contacts 206a-b and 208a-b, respectively.

View (A) shows package 200A having substrate 201 with transformer magnetic core 210 and primary and secondary coils 222 and 224. Package 200A is generally similar to package 100 of FIG. 1 except coils 222 and 224 include insulated wires with through hole soldering used for connection of ends 223 and 225 to conductive structures (completing the coil windings) in substrate 201.

View (B) shows package 200A having substrate 201 with transformer magnetic core 210 and primary and secondary coils 222 and 224. Package 200A is generally similar to package 100 of FIG. 1 except coils 222 and 224 include uninsulated wires with through hole soldering used for connection of wire ends 223 and 225 to conductive structures (completing the coil windings) in substrate 201. In view (B) insulative material, e.g., tape, (not shown) may be present between wires used for coils 222 and 224. In other embodiments, flexible ribbon or cables (e.g., woven), bands, strips, or other suitable conductive structure(s), either insulated or uninsulated, may be used for coils 222, 224 instead of wires.

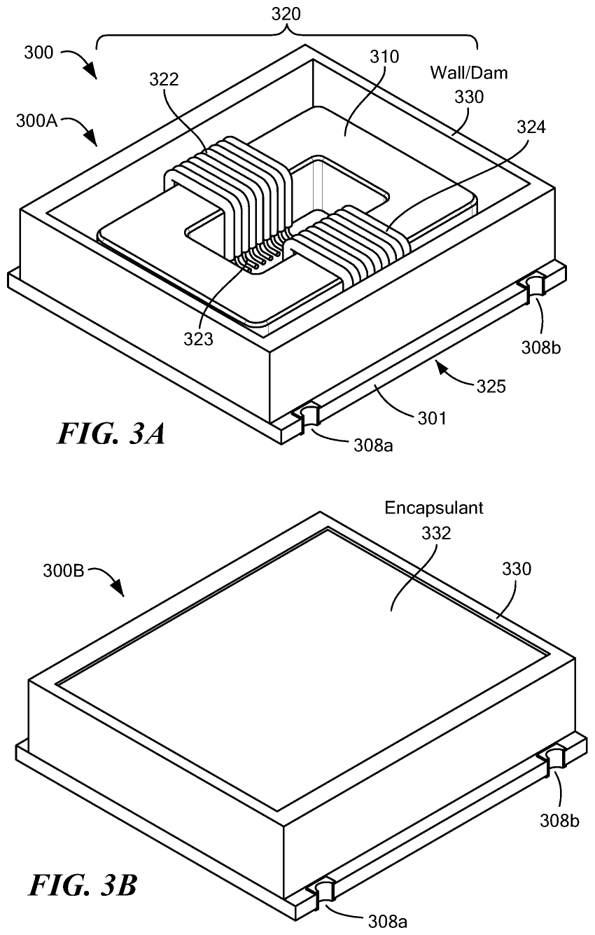

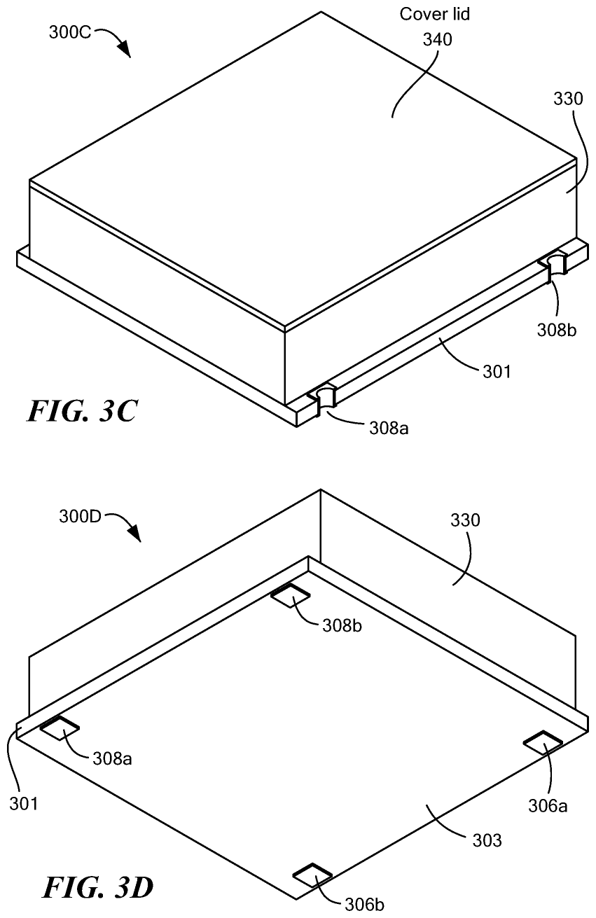

FIG. 3 includes views (A)-(D) showing a further example of a leadless transformer package 300 at different stages of fabrication, in accordance with the present disclosure. Corresponding package structures 300A-300D are shown in views (A)-(D), respectively.

As shown in view (A) package 300 includes substrate 301 with opposed first and second surfaces (sides) 302, 303. In some embodiments, substrate 301 can include a printed circuit board (PCB). Substrate 301 can include a plurality of conductive structures 304, which may be on a surface of substrate 301 and/or included in the interior of substrate 301. Multiple structures for connection to other components can be included, e.g., as indicated by solder contacts (pads) 306a-b and 308a-b.

Package 300 also includes transformer 320 with primary coil 322 and secondary coil 324 configured about transformer core 310 and galvanically separated. Transformer core 310 can include one or more soft (referring to magnetic property) ferromagnetic materials. Primary coil 322 and secondary coil 324 can each have a desired number of windings, which may differ from coil to coil. Portions of primary and secondary coils 322 and 324 are shown configured (wound) about core 310 as wire, with respective ends 323 and 325 connected to conductive structures on surface 302 or in substrate 301; other portions (not shown) of primary and secondary coils 322 and 324 are included within or on substrate 301 (e.g., as buried conductive traces), completing the windings about core 310. Coils 322 and 324 can be connected to respective sets of connection structures, e.g., solder contacts 306a-b and 308a-b, respectively. Package 300 can include wall (dam) 330, which can be configured to retain an encapsulant as described below. In some embodiments, dam (wall) 330 can include a plurality of sidewalls (walls), e.g., forming a closed polygon; in some embodiments, dam 330 includes walls configured in an open (not closed) configuration. In some embodiments, wall 330 may be configured around a perimeter of substrate 301.

View (B) shows package structure 300B including encapsulant (encapsulate) material 332 added to structure 300A of View (A). As shown, encapsulant material may be disposed in (dispensed with) wall 330. Encapsulant 332 can include or be composed of any suitable protective and/or dielectric material.

View (C) shows structure 300C including optional lid (cover) 340 added to structure 300B of View (B). In some embodiments, lid 340 can be sealed (e.g., welded or affixed with adhesive) to wall 330. View (D) is a bottom perspective view of structure 300B or 300C, showing surface 303 of substrate 301 and solder contacts (pads) 306a-b and 308a-b.

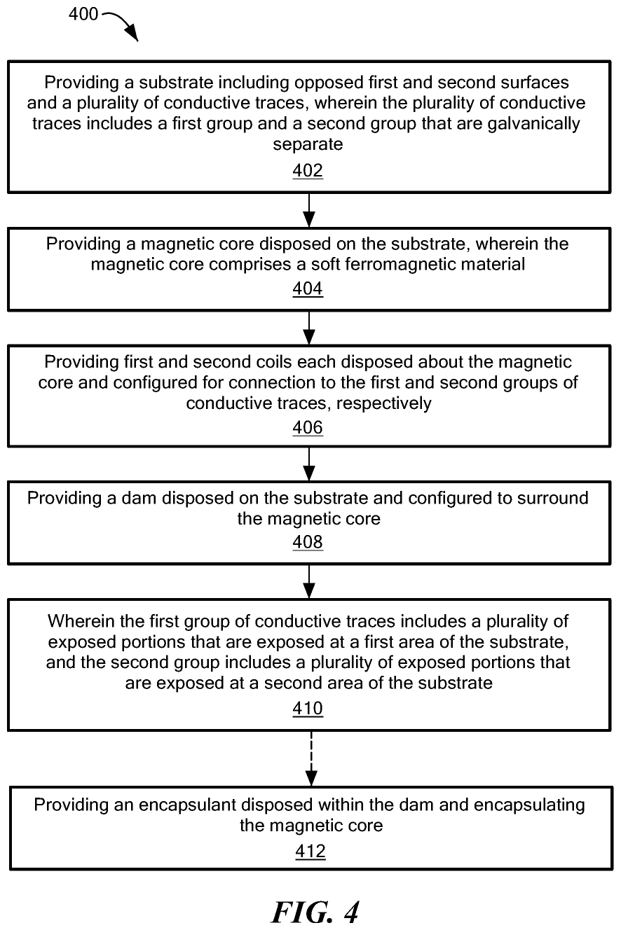

FIG. 4 shows steps for an example method 400 of fabricating a leadless transformer package, in accordance with the present disclosure. Method 400 can include providing a substrate including opposed first and second surfaces and a plurality of conductive traces, with the plurality of conductive traces including a first group and a second group that are galvanically separate, as described at 402. In some embodiments, a substrate may be a laminated structure. Examples of suitable substrates may include, but are not limited to, PCB, cofired ceramic substrates (high temperature or low temperature), alumina substrates, glass substrates, and/or the like. A magnetic core can be provided that is disposed on the substrate, with the magnetic core including a soft ferromagnetic material, as described at 404. Any suitable soft ferromagnetic material(s) may be used for the core. Examples of suitable core materials may include, but are not limited to, ferrite, powered iron, iron alloys, nickel alloys (including FeNi), ferrosilicon, etc. In some embodiments, a core material may be sintered.

First and second coils can be provided that are each disposed about the magnetic core and configured for connection to the first and second groups of conductive traces, respectively, as described at 406. Any suitable conductive structure(s) may be used for the coils. Examples of coils structure may include, but are not limited to, wires (insulated or uninsulated), flexible cable (e.g., woven), either insulated or uninsulated bands, strips, etc. The coils may include portions (e.g., portions of windings) that are outside of a package substrate; the coils may include portions (e.g., portions of windings) that are interior to or inside the substrate (e.g., as conductive traces and/or interconnect structures such as through-holes or vias). In some embodiments, copper may be used for the coils, though any suitable conductive structures/materials may be used within the scope of the present disclosure.

A wall or dam can be provided that is disposed on the substrate and configured to surround the magnetic core, as described at 408. The first group of conductive traces can include a (first) plurality of exposed portions that are exposed at a first area (or areas) of the substrate, and the second group of conductive traces can include a (second) plurality of exposed portions that are exposed at a second area (or areas) of the substrate, as described at 410. In some embodiments, method 400 can include providing an encapsulant disposed within the dam and encapsulating the magnetic core, as described at 412.

In some examples and/or embodiments, conductive features of the primary and secondary sides of a transformer structure in a transformer package according to the present disclosure can be fabricated or configured to have a desired separation distance (d) between certain parts or features, e.g., to meet internal creepage or external clearance requirements for a given pollution degree rating as defined by certain safety standards bodies such as the Underwriters Laboratories (UL) and the International Electrotechnical Commission (IEC). For example, such a separation distance may be between closest (voltage) points of the respective circuits, e.g., the low-voltage (primary) side and high-voltage (secondary) side. For further example, such a separation distance may be the distance between any two voltage points between the primary and secondary sides or a distance between exposed leads of primary and secondary sides of a transformer, may be or may be at least 1.2 mm, 1.4 mm, 1.5 mm, 3.0 mm, 4.0 mm, 5.5 mm, 7.2 mm, 8.0 mm, 10 mm, or 10+mm in respective examples. Such a distance between conductive portions or areas of die can include any insulation covering a conductor, e.g., such as plastic coating of a wire/lead. Other distances between conductive parts, components, and/or features of a transformer package may also be designed and implemented, e.g., to meet desired internal creepage, voltage breakdown, or external clearance requirements, e.g., between external leads.

In some examples and embodiments, a dielectric material (e.g., gel) may be used for potting and/or protecting substrate (e.g., PCB) systems, assemblies, and/or packages, to protect transformer components, coils, and/or interconnects from environment conditions and/or to provide dielectric insulation. In some embodiments, a suitable dielectric material can include a non-gel dielectric material. In some examples, a dielectric material may include, but is not limited to, one or more of the following materials: DOWSIL™ EG-3810 Dielectric Gel (made available by The Dow Chemical Corporation, a.k.a., “Dow”, and DOWSIL™ EG-3896 Dielectric Gel (made available by Dow), which has the ability to provide isolation greater than 20 kV/mm. Other suitable gel materials may also or instead be used, e.g., to meet or facilitate meeting/achieving voltage isolation specifications required by a given package design. DOWSIL™ EG-3810 is designed for temperature ranges from −60° C. to 200° C. and DOWSIL™ EG-3896 Dielectric Gel −40° C. to +185° C.; both of which can be used to meet typical temperature ranges for automotive applications.

Accordingly, embodiments and/or examples of the inventive subject matter can afford various benefits relative to prior art techniques. For example, embodiments and examples of the present disclosure can enable or facilitate use of smaller size packages for a given power, current. or voltage rating. Embodiments and examples of the present disclosure can enable or facilitate lower costs and higher scalability for manufacturing of transformer packages/modules having voltage-isolation (galvanic isolation) transformers.

Various embodiments of the concepts, systems, devices, structures, and techniques sought to be protected are described above with reference to the related drawings. Alternative embodiments can be devised without departing from the scope of the concepts, systems, devices, structures, and techniques described.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising,” “include,” “includes,” “including,” “has,” “having,” “contains” or “containing,” or any other variation are intended to cover a non-exclusive inclusion. For example, an apparatus, a method, a composition, a mixture, or an article, which includes a list of elements is not necessarily limited to only those elements but can include other elements not expressly listed or inherent to such apparatus, method, composition, mixture, or article.

Additionally, the term “exemplary” means “serving as an example, instance, or illustration.” Any embodiment or design described as “exemplary” is not necessarily to be construed as preferred or advantageous over other embodiments or designs. The terms “one or more” and “at least one” indicate any integer number greater than or equal to one, i.e., one, two, three, four, etc.; those terms may, however, refer to fractional values where context admits, e.g., “one or more” windings of a coil may refer to 1.5, 3, 4.66, 7, 9.2 windings, etc. The term “plurality” indicates any integer number greater than one; that term may also refer to fractional values greater than one, where context admits, e.g., for windings of a coil. The term “connection” can include an indirect connection and a direct connection.

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed but are used merely as labels to distinguish one claim element having a certain name from another element having a same name (but for use of the ordinal term) to distinguish the claim elements.

The terms “approximately” and “about” may be used to mean within ±20% of a target (or nominal) value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within +5% of one another in some embodiments, and yet within ±2% of one another in some embodiments.

The term “substantially” may be used to refer to values that are within ±20% of a comparative measure in some embodiments, within +10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and carried out in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. A leadless transformer package comprising:
a substrate including opposed first and second surfaces and a plurality of conductive traces, wherein the plurality of conductive traces includes a first group and a second group that are galvanically separate, and wherein the first group includes a plurality of exposed portions that are exposed at a first area of the substrate, and the second group includes a plurality of exposed portions that are exposed at a second area of the substrate;
a magnetic core disposed on the substrate, wherein the magnetic core comprises a soft magnetic material;
first and second coils each disposed about the magnetic core and configured for connection to the first and second groups of conductive traces, respectively;
a dam disposed on the substrate and configured to surround the magnetic core; and
an encapsulant disposed within the dam and encapsulating the magnetic core.

2. The transformer package of claim 1, wherein the dam comprises a plurality of walls disposed on the first surface of the substrate.

3. The transformer package of claim 2, wherein the dam further comprises a cover connecting the plurality of walls.

4. The transformer package of claim 1, wherein the substrate comprises a laminated structure.

5. The transformer package of claim 1, wherein the substrate comprises a printed circuit board (PCB).

6. The transformer package of claim 1, wherein the substrate comprises one or more layers of low-temperature cofired ceramic (LTCC) or high-temperature cofired ceramic (HTCC).

7. The transformer package of claim 1, wherein the substrate comprises an alumina substrate.

8. The transformer package of claim 1, wherein the substrate comprises a glass substrate comprising one or more layers of metal and insulation.

9. The transformer package of claim 5, wherein the PCB comprises FR4.

10. The transformer package of claim 5, wherein the PCB comprises FR5.

11. The transformer package of claim 1, wherein the first and/or second coil comprises insulated wire.

12. The transformer package of claim 1, wherein the first and/or second coil comprises uninsulated wire.

13. The transformer package of claim 1, wherein the first and/or second coil comprises insulated ribbon cables.

14. The transformer package of claim 1, wherein the first and/or second coil comprises flexible ribbon cables.

15. The transformer package of claim 1, wherein the first and second coils are configured as primary and secondary coils in a step-up configuration.

16. The transformer package of claim 1, wherein the magnetic core comprise ferrite.

17. The transformer package of claim 1, wherein the magnetic core comprises a nickel alloy.

18. The transformer package of claim 1, wherein the magnetic core comprises a ferrosilicon.

19. The transformer package of claim 1, wherein the magnetic core comprises iron particles.

20. The transformer package of claim 1, wherein the encapsulant comprises silicone.

21. A method of making a leadless transformer package, the method comprising:
providing a substrate including opposed first and second surfaces and a plurality of conductive traces, wherein the plurality of conductive traces includes a first group and a second group that are galvanically separate, and wherein the first group includes a plurality of exposed portions that are exposed at a first area of the substrate, and the second group includes a plurality of exposed portions that are exposed at a second area of the substrate;
providing a magnetic core disposed on the substrate, wherein the magnetic core comprises a soft magnetic material;
providing first and second coils each disposed about the magnetic core and configured for connection to the first and second groups of conductive traces, respectively;
providing a dam disposed on the substrate and configured to surround the magnetic core; and
providing an encapsulant disposed within the dam and encapsulating the magnetic core.

22. The method of claim 21, wherein the dam comprises a plurality of walls disposed on the first surface of the substrate.

23. The method of claim 22, wherein the dam further comprises a cover connecting the plurality of walls.

24. The method of claim 21, wherein the substrate comprises a laminated structure.

25. The method of claim 21, wherein the substrate comprises a printed circuit board (PCB).

26. The method of claim 21, wherein the substrate comprises one or more layers of low-temperature cofired ceramic (LTCC) or high-temperature cofired ceramic (HTCC).

27. The method of claim 21, wherein the substrate comprises an alumina substrate.

28. The method of claim 21, wherein the substrate comprises a glass substrate comprising one or more layers of metal and insulation.

29. The method of claim 21, wherein the first and/or second coil comprises insulated wire.

30. The method of claim 21, wherein the first and/or second coil comprises uninsulated wire.

31. The method of claim 21, wherein the first and/or second coil comprises insulated ribbon cables.

32. The method of claim 21, wherein the first and/or second coil comprises flexible ribbon cables.

33. The method of claim 21, wherein the first and second coils are configured as primary and secondary coils in a step-up configuration.

34. The method of claim 21, wherein the magnetic core comprise ferrite.

35. The method of claim 21, wherein the magnetic core comprises a nickel alloy.

36. The method of claim 21, wherein the magnetic core comprises ferrosilicon.

37. The method of claim 21, wherein the magnetic core comprises iron particles.

38. The method of claim 21, wherein the encapsulant comprises silicone.
